(19) United States
(12) Patent Application Publication
(10) Pub. No.: US 2014/0208436 A1
(43) Pub. Date: Jul. 24, 2014

(54) ALPHA II LICENSE MANAGEMENT SYSTEM

(71) Applicant: BALLY GAMING, INC., Las Vegas, NV (US)

(72) Inventors: Pravinkumar Patel, Las Vegas, NV (US); Nathan K. Harvey, Pahrump, NV (US); Joshua D. Larsen, Las Vegas, NV (US)

(73) Assignee: BALLY GAMING, INC., Las Vegas, NV (US)

(21) Appl. No.: 14/220,325

(22) Filed: Mar. 20, 2014

Related U.S. Application Data
(63) Continuation of application No. 12/828,152, filed on Jun. 30, 2010.
Application No. 12/828,152 is a continuation-in-part of application No. 12/263,342, filed on Oct. 31, 2008.
Application No. 12/263,342 is a continuation-in-part of application No. 11/938,249, filed on Nov. 9, 2007.
(60) Provisional application No. 61/029,612, filed on Feb. 19, 2008.

(51) Int. Cl. G06F 21/10

(52) U.S. Cl. CPC G06F 21/105
USPC 726/26

(57) ABSTRACT

The Alpha II installation architecture requires extra management of per-seat installations to ensure the games are only installed with as many instances as were sold to the site. The License Management method manages and enforces proper per-license activation since a mechanism is present on the gaming machines to copy the software which is sold on compact flashes and installed onto hard drives. A method for providing license management using an activation application to manage and enforce proper per-license activation is disclosed. The method includes: adding purchased game titles to an active license database; requesting activation installations for game titles that are desired to be activated on associated gaming machines; creating activation installations on a portable memory device that associates the activation installations with associated gaming machines; enabling software to be installed onto each machine which the software is inserted using the portable memory device; enabling return of the portable memory device to the activation application where the portable memory device is read, after completion of the gaming machines being updated; and passing the current snapshot and confirmation data to a central licensing host to confirm the activation installations and free any uninstalled software licenses.

### CROSS-REFERENCE TO RELATED APPLICATIONS

This application is a Continuation of U.S. patent application Ser. No. 12/828,152, filed Jun. 30, 2010, entitled “Alpha II License Management System.” This application is also a Continuation-in-part of U.S. patent application Ser. No. 12/263,342, filed Oct. 31, 2008, entitled “License Management System” which is a Continuation-in-part of U.S. application Ser. No. 11/938,249, filed Nov. 9, 2007, entitled “Download and Configuration Capable Gaming Machine Operating System, Gaming Machine and Method; U.S. patent application Ser. No. 12/263,342 also claims priority to U.S. Provisional Application No. 61/029,612, filed Feb. 19, 2008, entitled “License Management System and Method”. All of the above are expressly incorporated herein by reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD

This invention pertains generally to gaming machine systems and methods. More particularly, the present invention relates to gaming machines with updateable gaming software and methods to ensure that proper licensing is maintained of this software.

### BACKGROUND

In modern gaming environments, some types of installation architecture require extra management of per-seat installations to ensure the games are only installed with as many instances as were sold. In such an environment, there is a continuing need in the art for a system or method that manages and enforces proper per-license activation since some gaming machines have the ability to copy software onto their hard drives.

### SUMMARY

Briefly, and in general terms, the license manager provides an automated process that reduces the need for human interaction associated with licensing components, distribution of the same, product distribution, debugging, product building, assembly, installation, configuration and maintenance. In one embodiment, a method for providing license management using an activation application to manage and enforce proper per-license activation is disclosed herein. The method includes: adding each purchased game title to an active license database; requesting activation installations for game titles that are desired to be activated on gaming machines on which the game titles are desired to be associated; creating an install compact flash that associates activation installations to particular gaming machines; installing software that is chosen by an operator and destined by a license, for each machine into which the software is inserted using the compact flash; returning the compact flash to the activation application, where the compact flash is read, after completion of the gaming machines being updated; and passing the current snapshot and confirmation data to a central licensing host to confirm the activation installations and free any uninstalled software licenses.

In another aspect of one embodiment, the license management method further includes: having a customer or technician log into the activation application to request activation installations for game titles that are desired to be activated on gaming machines on which the game titles are desired to be associated. In still another aspect, the compact flash is created as a step in a manufacturing process for a given game. In yet another aspect, the compact flash is generated locally on a computer having a flash burner and internet connection. Continuing, in another aspect of one embodiment, the license management method further includes enabling a field technician or operator to take the created compact flash to each of the gaming machines.

In another embodiment of the license management method, the new software is installed over existing software. In some embodiments, the new software is installed over the existing software by uninstalling the existing software and producing a new snapshot of current system installations and confirmation data. Preferably, the snapshot of current system installations and confirmation data is stored on the compact flash. In another aspect of one embodiment of the license management method, the license management system is capable of being used in any sized establishment including large multiple property casinos, a single property casino, or a convenience store, tavern, or bar.

In one embodiment, the license management system provides enablement/disablement of software products, generation and maintenance of accounting records, and logs for licenses that are generated and distributed throughout the system. An audit trail is also created that includes who authorized the purchase of the license, as well as audit trails relating to different system levels to verify system security. Finally, a change notification system provides for the control of any changes to the system and monitors these changes on a multi-tiered level within the system.

Further aspects, features and advantages of various embodiments of the invention will be apparent from the following detailed disclosure, taken in conjunction with the accompanying sheets of drawings.

### BRIEF DESCRIPTION OF THE DRAWINGS

FIG. 1 is a Process Infrastructure Display of the license management system and method.

FIG. 2 is a Process Infrastructure Flowchart of the license management system and method.

FIG. 3 is a Core Process Display of the license management system and method.

FIG. 4 is an Install Flash of the license management system and method.

FIG. 5 is a Site Application Design of the license management system and method.

FIG. 6 is a User Interface Process of the license management system and method.

FIG. 7 is an Activation Host Design of the license management system and method.

FIG. 8 is an Initial Established Gaming Machine ID Process of the license management system and method.

FIG. 9 is an embodiment of the User Login screen.

FIG. 10 is a main page menu screen of available options.

FIG. 11 is a Create Compact Flash Screen of the Alpha II License Management system.

FIG. 12 is a Create Compact Flash Progress Screen of the activation application.

FIG. 13 is a Read Used Compact Flash Screen of the license management system and method.

FIG. 14 is a Review Licenses Screen of the license management system and method.

FIG. 15 is a Manage Database Screen of the license management system and method.

FIG. 16 is a Manage Parts Screen of the license management system and method.

FIG. 17 is a Manage Customers Screen of the license management system and method.

FIG. 18 is a Manage Users Screen of the license management system and method.

FIG. 19 is a Login as Customer Screen of the license management system and method.

FIG. 20 is a Purchase New Titles Screen of the license management system and method.

FIG. 21 is a Configuration Options Screen of the license management system and method.

### DETAILED DESCRIPTION OF THE PREFERRED EMBODIMENTS

Disclosed herein are several embodiments of a license management system and method using an activation application to manage and enforce proper per-license activation. Gaming machines and methods are also described which implement the license management using an activation application. The Alpha II installation architecture requires extra management of per-seat installations to ensure the games are only installed with as many instances as were sold to the site. The license management system and method manages and enforces proper per-license activation since a mechanism is present on the gaming machines to copy the software which is sold on compact flashes and installed onto hard drives.

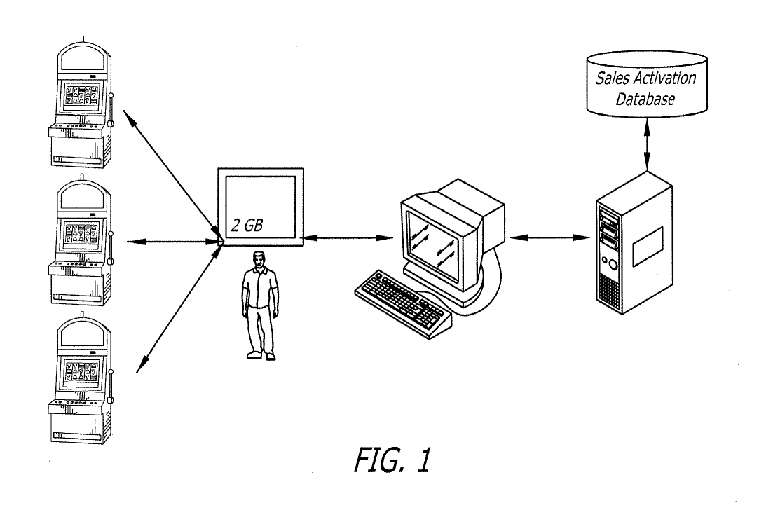

In one embodiment, a method for providing license management using an activation application to manage and enforce proper per-license activation includes: adding purchased game titles to an active license database; requesting activation installations for game titles that are desired to be activated on associated gaming machines; creating activation installations on a portable memory device that associates the activation installations with associated gaming machines; enabling software to be installed onto each machine on which the software is inserted using the portable memory device; enabling return of the portable memory device to the activation application where the portable memory device is read, after completion of the gaming machines being updated; and passing the current snapshot and confirmation data to a central licensing host to confirm the activation installations and free any uninstalled software licenses. Referring now to the drawings, wherein like reference numerals denote like or corresponding parts throughout the drawings and, more particularly to FIGS. 1-8, there is shown one embodiment of a network gaming environment that utilizes a license management system.

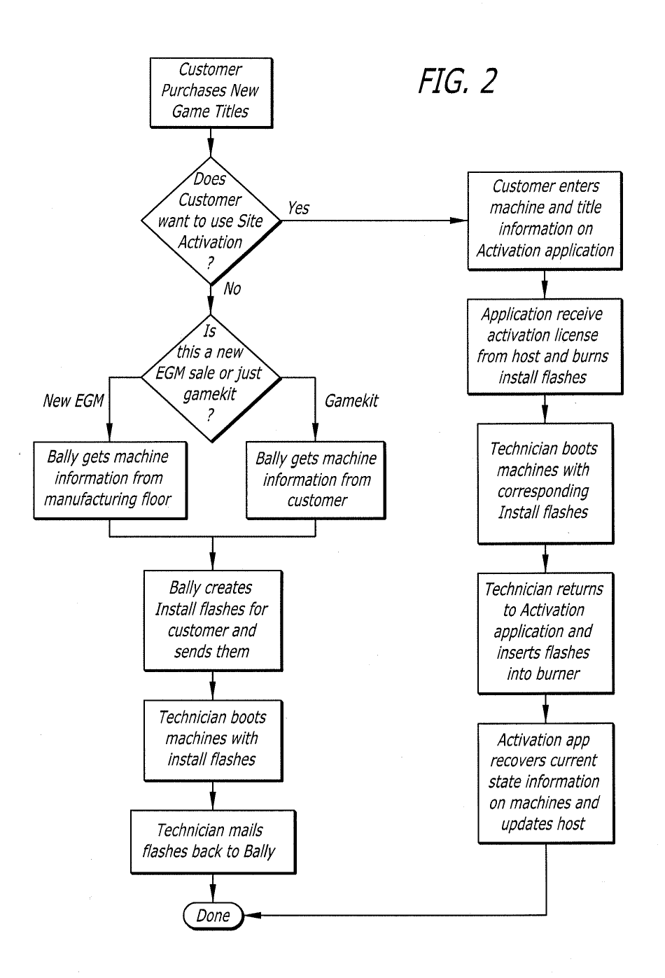

Referring now to FIG. 1, an embodiment of a process infrastructure display of the Alpha II License Management system is shown. FIG. 1 shows the process detailed in this document that provides the infrastructure needed for a truly secure licensing system while also providing convenient mechanisms to prevent data entry and other overhead for the operators. FIG. 2 displays the process infrastructure in flowchart form.

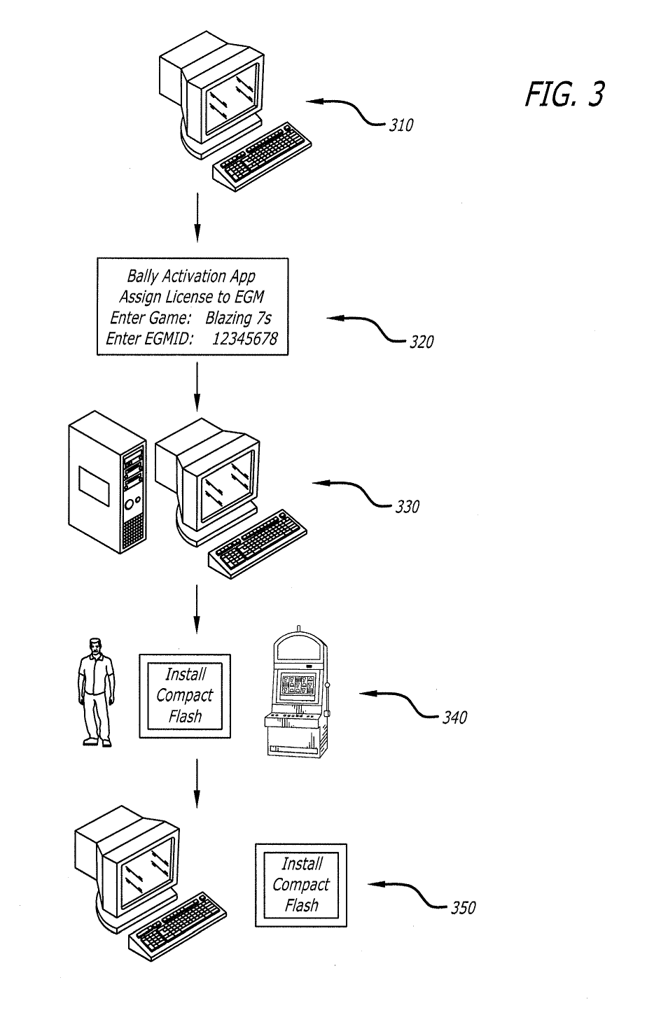

Continuing, FIG. 2 shows two possible embodiments in a process infrastructure flowchart of the Alpha II License Management system. FIG. 3 also shows an embodiment of the core process display of the Alpha II License Management system. The core process includes: (1) In Step 310, adding each purchased game to the manufacturer's Active License Database. (2) In Step 320, having a customer or technician log into the manufacturer's Activation Application and request activation installs for the titles they want to activate and for the machines with which they want to associate the titles. (3) In Step 330, creating an install flash that associates the activation installs to particular machines. This flash may be created as a step in the manufacturing process for a given game order, or it may be generated locally from a Windows® machine on site that has a flash burner and internet connection. (4) In Step 340, having a field technician or operator takes the compact flash to each of the machines. This compact flash installs the software that is chosen by the operator and destined (by the license) for each machine into which it is inserted. This procedure installs the new software over the existing software by uninstalling the old software and producing a new snapshot of the current system installations, as well as some confirmation data. This data is stored on the compact flash. (5) In Step 350, when all of the machines are finished being updated, the compact flash is brought back to the manufacturer's Activation Application, where the compact flash is read. The current snapshot and confirmation data are passed to the central licensing host to confirm the activation and free any uninstalled software licenses.

As shown in FIG. 3, the core process may be abbreviated for customer convenience or phased development such that the install flashes may be created by the manufacturer and sent to the customer. This approach places the responsibility of process steps 310 through 330 on the manufacturer. Lastly, step 350 includes returning the flashes to the manufacturer.

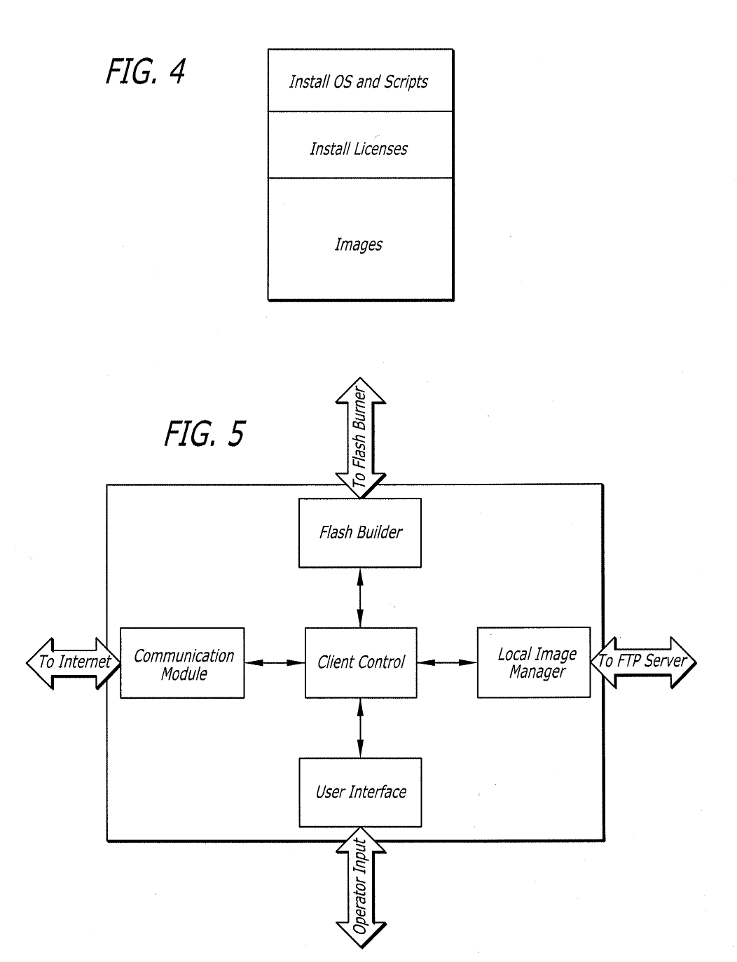

Continuing, FIG. 4 shows an embodiment of the Install Flash of the Alpha II License Management system. As shown in FIG. 4, the Install Flash contains all of the components required to enable proper licensing to be authenticated and installed on a particular gaming machine. In this regard, there are typically three partitions used to store the required data: the OS and scripts installation partition, licenses installation partition, and the images partition. The OS and scripts installation partition includes the rc.sysinit file that the kernel uses to boot the Install application. This partition also includes the entire installation scripts that are used to remove old games from the gaming machine and replace them with the new games. The licenses installation partition includes the actual files with activation codes for specific activations. The images partition stores all the installable images and/or packages.

Referring now to the License Manager, management of the activation is preferably handled by a new class in the GameMgr (i.e., Game Manager). This configuration encapsulates the duties that are needed for the activation, keeping updates to the functionality of the system localized, and preventing duplication of the code. Additionally, the License Manager controls the file management that is used to track activation status, as well as presenting the list of active and inactive games to the rest of the system.

```
class LicenseManager
{
public:
  LicenseManager( );
  ~LicenseManager( );
  std::vector<std::string> GetActivatedGames( );
  std::vector<std::string> GetInactivatedGames( );
  LicenseRequest GetActivationRequest( );
  bool Activate(LicenseResponse const& response);
  bool Deactivate(std::string const& componentName);
  void DeactivateAll( );
};
```

The Alpha II License Management system also addresses the storing game activations (and the appearance to the rest of the machine). In a preferred embodiment of the Alpha II License Management system, after a game is installed, before the game becomes active, the game is marked as inactive. This information is stored in the Critical Data partition of the Hard Drive, in a structure by the OS that keeps the pending activation status of all components on the machine that may be activated, including the dynamic (not hardware specific) data generated for the authentication host. This ensures that the data given to the host is matched up properly in the event of power hits before activation completes.

In another aspect of the Alpha II License Management system, new games that have been added to the gaming machine that are inactive do not count as games on the machine for normal operation. Such games do not appear on the manifest lists in the operator menu. Additionally, these games are not components that may be validated through GAT or SAS protocol standards. These games are only accessed when a user enters a screen in which to activate inactive games.

The file format is a binary save of an ActivationFile message stream object, as shown as follows:

```
class ActivationStorage : public MessageStreamObject
{
public:
virtual void Serialize(MS::MsgStream & stream);
private:
  bool active_;
  Blob activationCode_;
  std::string dateActivated_;
};
class ActivationFile : public MessageStreamObject
{
public:
virtual void Serialize(MS::MsgStream & stream);
private:
std::vector<ActivationStorage> activations_;
};
```

In the above listed code, the fields in parenthesis are specific information of the type described. Typically, there is one entry in the file for every installed part that is not activated. Additionally, the most recent session number for an install may be stored in the backplane EEPROM.

Referring now to the algorithm for activation codes, the activation algorithm of the Alpha II License Management system has the following characteristics: (1) the algorithm contains machine-specific information (i.e., the activation code does not work on other machines); (2) the algorithm contains random challenge information generated for a particular install session (the activation code does not work for other install sessions, even if on the same gaming machine); and (3) the authentication code is scalable to include additional information on new licensing models.

In one embodiment of the Alpha II License Management system, the code has sections mapped out for the known needs and allows the size to scale with future needs. In accordance with this configuration, the following information is used to generate a key in one embodiment: (1) Key version number (allows scalability of key types)—2 bytes; (2) Activation command—2 bytes; (3) Game ID (part number)—18 bytes; (4) Session ID (from host)—8 bytes; (5) Dallas ID—8 bytes; (6) License duration—4 bytes; (7) A piece of random information (from host)—8 bytes; (8) MAC Signature (DSS signature) to authenticate that it came from server (over fields 1-7)—52 bytes. This non-limiting embodiment gives a total version 1 license key size of just over 100 bytes of data, which is a reasonable size that does not need to be addressed through manual entry.

In one embodiment of the Alpha II License Management system, the key is generated in the following manner. First, concatenate the information presented (in that order) into 100 byte blob. Second, XOR the bytes one by one and store the resulting byte (which is referred to as N). XOR is short for exclusive OR. XOR may be described as meaning precisely one input must be 1 (true) for the output to be 1 (true). Otherwise stated, XOR may be defined as “one or the other but not both.” For example, an XOR gate is a digital logic gate that implements exclusive disjunction. A HIGH output (1) results if one, and only one, of the inputs to the gate is HIGH (1). If both inputs are LOW (0) or both are HIGH (1), then a LOW output (0) results.

Next, take the nth permutation of the full blob, using an unordered generation algorithm. A summary of this unordered generation algorithm may be given by the following code:

```
void ReverseSelectionPermute(Blob & blob, uint8 xorValue)
{
  for (size_t position(2); position <= blob.size( ); ++position)
  {
    uint8 temp(blob[xorValue % position]);
    blob[xorValue % position] = blob[position − 1];
    blob[position − 1] = temp;
    xorValue /= position;
  }
}
```

In one embodiment of the Alpha II License Management system, when an activation code is read by the gaming machines, the following steps are taken to authenticate the activation: (1) XOR the bytes one by one and store the resulting byte (referred to as N). Invert the Nth permutation and apply this inversion to the activation code. (2) Verify that the version is the one expected by this algorithm (1). (3) Verify that the session ID is greater than or equal to the previous session ID. Session IDs are stored in a place not cleared by clear flash, such as a critical data partition on the hard drive. This check ensures flash copying cannot be a useful means of piracy on a gaming machine. (4) Verify that the ID actually identifies this machine. (5) Authenticate the MAC signature. If steps pass, then the install may proceed for the game that corresponds (via step 2).

Continuing, FIG. 5 shows one embodiment of the site application design of the Alpha II License Management system. FIG. 5 displays the site application for the Alpha II License Management system, which consists of the following major modules: User Interface; Communications Module; Client Control; Local Image Manager; and Flash Builder. The Site Application also supports (1) creating an activated install flash (or set of flashes) for a set of machines, and (2) viewing activated and un-activated titles for a customer.

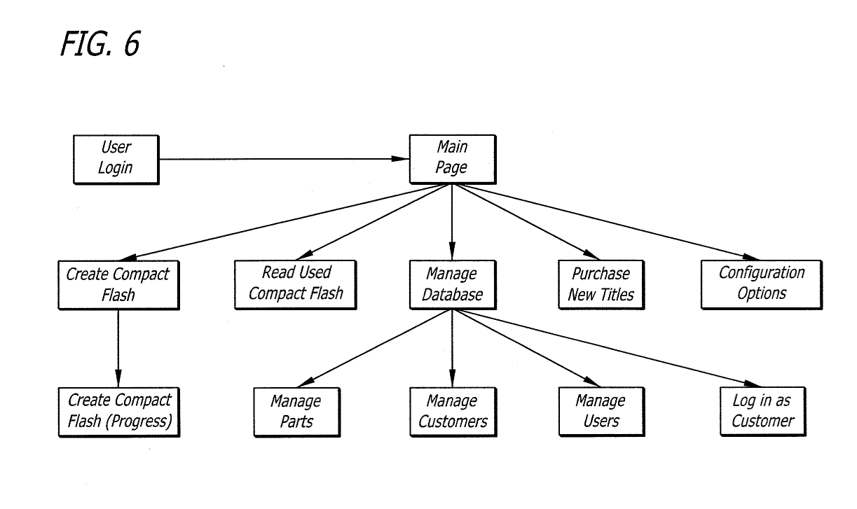

Referring now to FIG. 6, an embodiment of the user interface process of the Alpha II License Management system is shown. FIG. 6 displays the user interface, which includes the following windows that are available for customer interaction: User Login screen, Main Page, Create Compact Flash Screen, Create Compact Flash Progress Screen, Read Used Compact Flash Screen, Review Licenses Screen, Manage Database Screen, Manage Parts Screen, Manage Customers Screen, Manage Users Screen, Login As Customer Screen, Purchase New Titles Screen, and Configuration Options Screen.

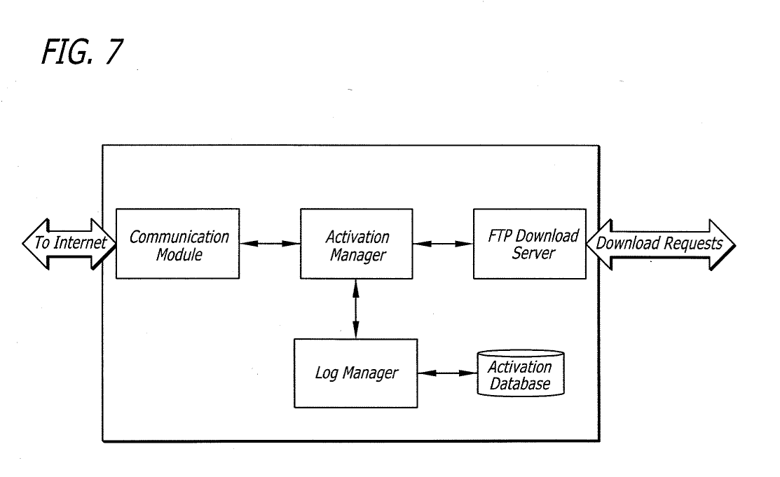

An embodiment of the activation host design of the Alpha II License Management system is displayed in FIG. 7. As shown in FIG. 7, the Activation Host design of the Alpha II License Management system includes the following modules: the communications module, the activation manager module, the log manager module, and the ftp download server.

In one embodiment, the communications module contains the communications and transport for the host. This module is similar to the client communications module. In another aspect of this embodiment, the activation manager controls the application layer and manages activation requests from the client. The activation manager also retrieves the relevant data from the log manager, and replies to the client with the data it has requested.

```
class ActivationManager
{
public:
  void ProcessLoginRequest(LoginInfo);
  void ProcessActivationRequest(ActivationRequest);
  void ProcessStateUpdate(MachineState);
};
```

In still another aspect of this embodiment, the log manager is the interface to the SQL database that contains all sales and activation data. Finally, in yet another aspect of this embodiment, the FTP download server is the storage system for image transfers. The FTP download server manages user access privileges and the file system. The FTP download server holds images and packages available for download by the licensing system.

In another aspect of one embodiment, the Alpha II License Management system includes an install activation screen. The games suggested for installation are the games with valid activation codes for the machines on which the flash is running. The activation validation is transparent to the end user.

In one embodiment of the Alpha II License Management system, license downloads are handled through the same license control scheme, and are adapted to use the FTP server as the main image transfer media. Games are activated by the customer through a manufacturer's representative, who authorizes the activation by placing the activation code onto the download FTP server. Once installed, the OS sends the activation response snapshot of the current state of machine installs to the FTP server. Preferably, download licenses are identified by an activation code command value of “2.”

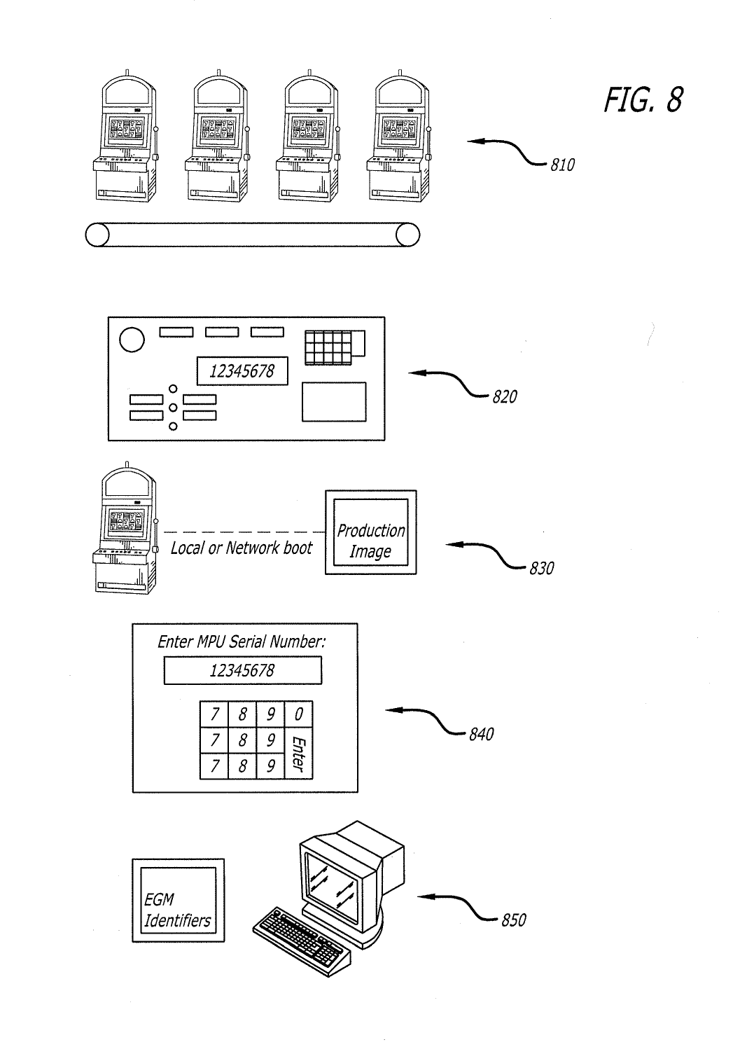

Referring now to FIG. 8, an embodiment of an initial established gaming machine ID process is shown. FIG. 8 shows that in one embodiment, all of the Alpha II machines are identified for tracking purposes in the Alpha II License Management system. The Activation code uses a particular identification ID for this purpose. This identification ID is considered a sensitive identifier since it is used for motherboard tracking in certificates and boot comparisons. The identifier is not accessible externally. Conversely, all externally available identifiers are not software accessible without direct input, opening means of identifier spoofing (breaking license management), so the internally accessible identification ID must be paired with an externally accessible identifier to allow the customer a way of identifying their machines in which to attach activations.

The process steps for this identification association, as shown in FIG. 8, include the following: (1) In Step 810, the machine comes out of production. (2) In Step 820, the MPU (master processing unit) is assigned a serial number, affixed to a sticker on the outside. (3) In Step 830, the machine is booted with a “Production Image.” This may occur either through a network boot or by compact flash. (4) In Step 840, the MPU serial number is read by an operator (possibly through a barcode reader or similar automated device) and entered into the machine, where it is saved back to the compact flash along with the identification ID chip. At this point, inactive games may also be installed as a part of the production process. (5) Steps 820-840 are repeated for all MPUs coming out of production. (6) Finally, in Step 850, the gaming machine identifiers are read into the database, either from compact flash or network image. The database holds entries for all MPUs that leave production, associating their production serial numbers and internal chipset identifiers.

For customers with existing machines on the floor, the system may need to get the identification IDs off of the existing machines, if there were Alpha II cabinets produced prior to the establishment of the licensing system. This may be done using the same process as normal production, though no game images are transferred. Instead, a flash without images identifies itself as a state on which flash is recorded. This records all the relevant machine information, which is then reported to the main database through the site application or by mailing the flashes back to the manufacturer.

A preferred embodiment of the disclosed invention provides scalable license management that works with widely distributed low machine count installations like gas stations as well as centrally located high machine count installations like large casinos. The system does not require extra host installations. Additionally, the system introduces a new mechanism of data collection for sales and marketing that can identify life spans of games, which game titles are currently active, and where the game titles are active. Also, data for some other types of per-customer statistics may be collected as well.

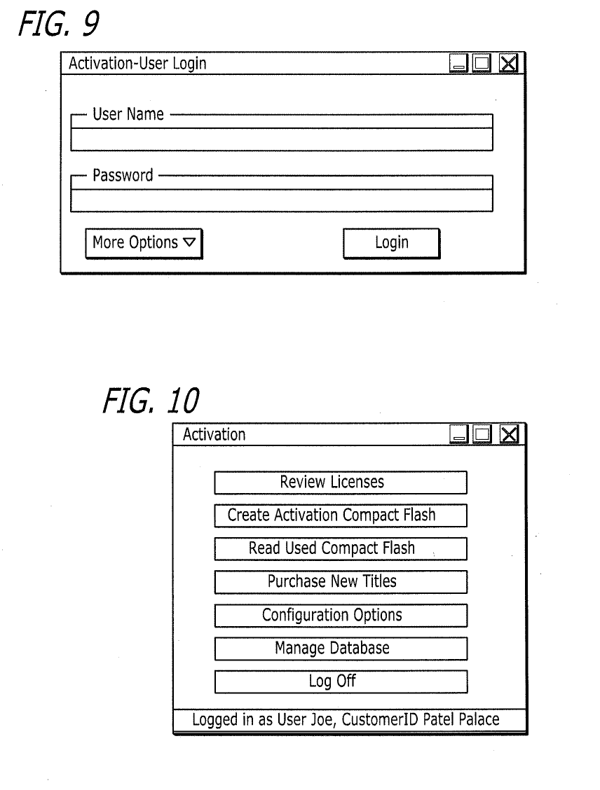

As described above in FIG. 6, one embodiment of a user interface of the Alpha II License Management system includes additional display screens associated with the user interface. These addition display screens are described below in the following sections. Referring now to FIG. 9, an embodiment of the User Login screen is shown. When a user first starts the activation application, the user is prompted to log into the User Login screen. The user provides credentials before being allowed to access the system. If the user desires to customize their login, the user may select the More Options button, which gives the user the capability to change their password or specify a custom location for the host. As shown in FIG. 10, once the user has logged on, the user is presented with a main page menu screen of available options. This main page leads the users to the various tasks the activation application may perform.

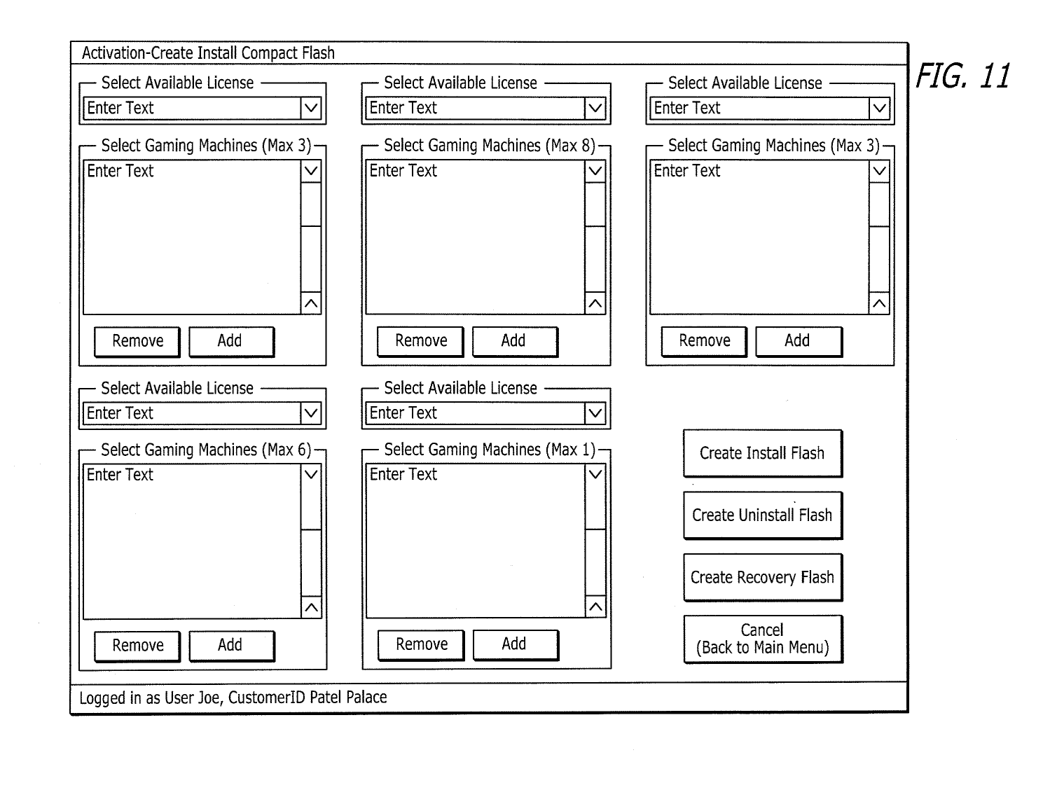

Referring now to FIG. 11, an embodiment of the Create Compact Flash Screen of the Alpha II License Management system is shown. Creating compact flashes is a significant function of the activation application. In one embodiment of the Create Compact Flash screen, the user may select up to five different game licenses to prepare for a flash burn. Each of these licenses may be assigned to as many games of the selected game type as the user has available licenses. Available game licenses are selected through a “Select Available License” drop down box. Additionally, the combo box shown in the Create Compact Flash Screen may be filled out with machine identifiers using the “Remove” and “Add” buttons. When completed, the “Create Install Flash” takes the user to the screen to burn copies of the selected image and indicate progress of the burning.

Also available to the user is the ability to “Create Uninstall Flash” for removing titles, and “Create Recovery Flash” to record the current state of the machines. This latter option is expected to be used in situations where a user has burnt installations for a machine and associated license that the user later decides he does not wish to use.

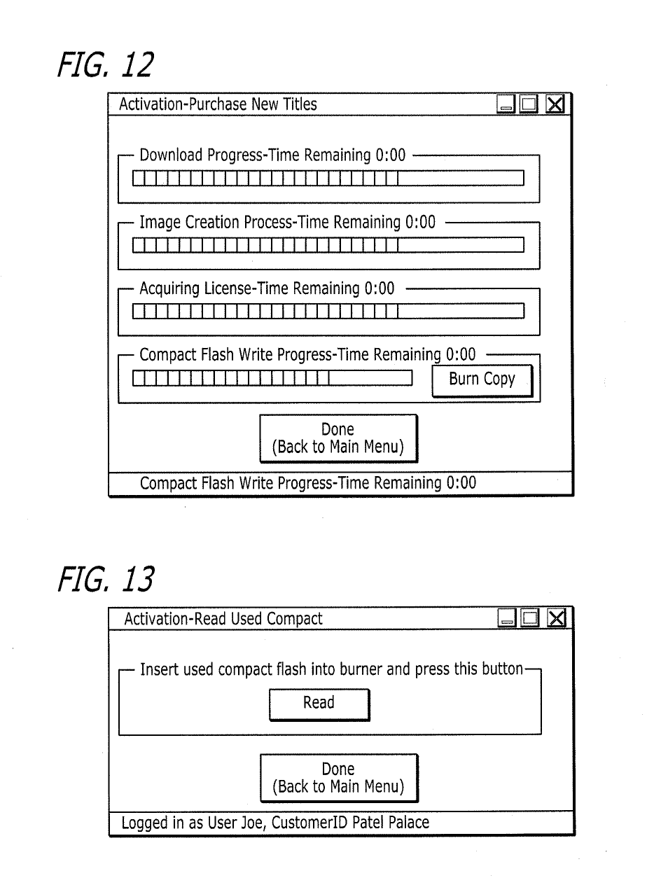

Referring now to FIG. 12, an embodiment of the Create Compact Flash Progress Screen of the activation application is shown. The Create Compact Flash Progress Screen displays the progress of the compact flash burn. This screen enables the user to burn multiple copies of the flash image for convenient parallel installations. Referring now to FIG. 13, an embodiment of the Read Used Compact Flash Screen is shown. This screen displays the current state of the machine and the activation code response that is reported to the host, when a flash has been used for an install.

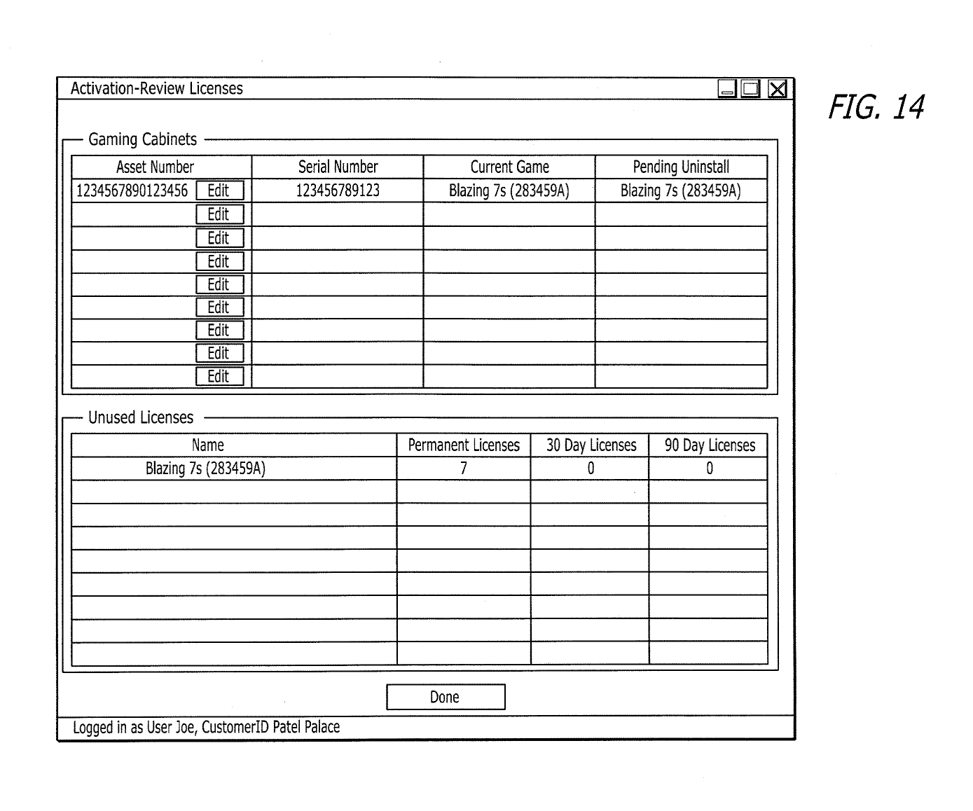

Referring now to FIG. 14, an embodiment of the Review Licenses Screen provides information on the host system's view of a customer's install base and available licenses. The screen presents a list of (1) all gaming machines known, (2) their asset numbers, (3) serial numbers, (4) the game currently expected to be on the machine, and (5) any uninstalls expected for that machine. In one embodiment, this screen also presents a list of all licenses a customer has which are not currently assigned to any gaming machine.

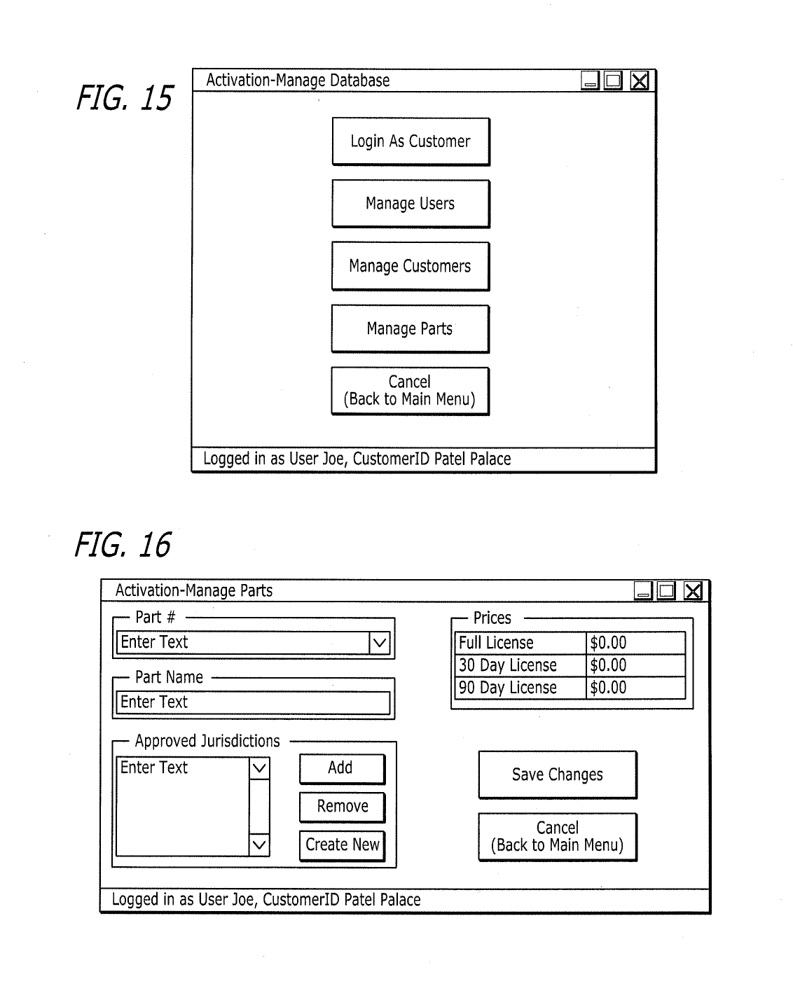

Referring now to FIG. 15, an embodiment of the Manage Database Screen is shown. Preferably, this screen provides the ability to manage the database, which is typically a privilege of administrator and sales users. This screen provides the various capabilities presented to these privileged users, including the ability to login as a customer (to view the interface presented to them), to manage the user records, to manage the customer records, and to manage the Parts records.

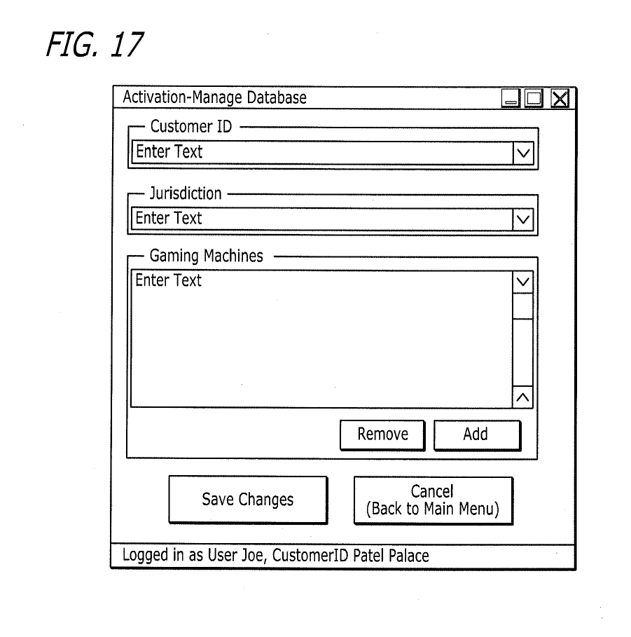

Continuing, FIG. 16 shows an embodiment of the Manage Parts Screen of the activation application. This screen enables a user to enter data for any available part numbers. The user may change the names, approved jurisdictions, and price of any given part. Referring now to FIG. 17, an embodiment of the manage customers screen is shown. This screen enables the editing or adding of customer information. The jurisdiction to which the customer is assigned may be altered, as well as the gaming machines known for that customer.

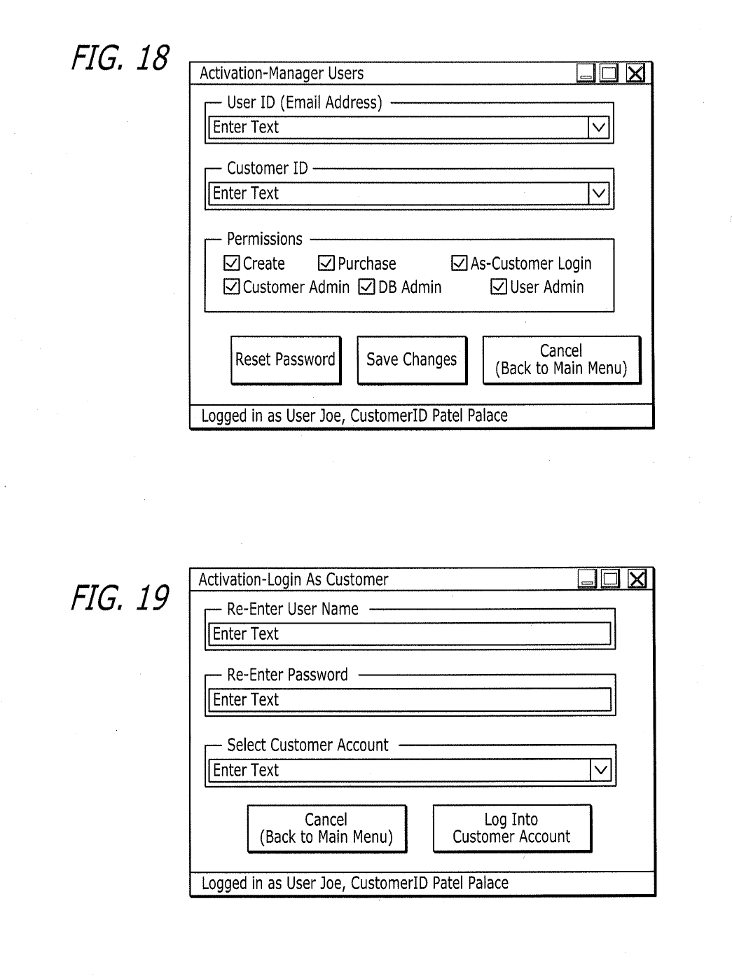

Referring now to FIG. 18, an embodiment of the manage users screen is shown. Editing user information is an administrator task to enable new accounts to be established or reassignment of privileges for existing accounts. This screen also enables passwords to be reset, which is a useful task when a user loses their password. Continuing, FIG. 19 shows an embodiment of the Login as Customer Screen. This screen enables a sales associate or administrator to view the interface to the activation application that is presented to a particular user.

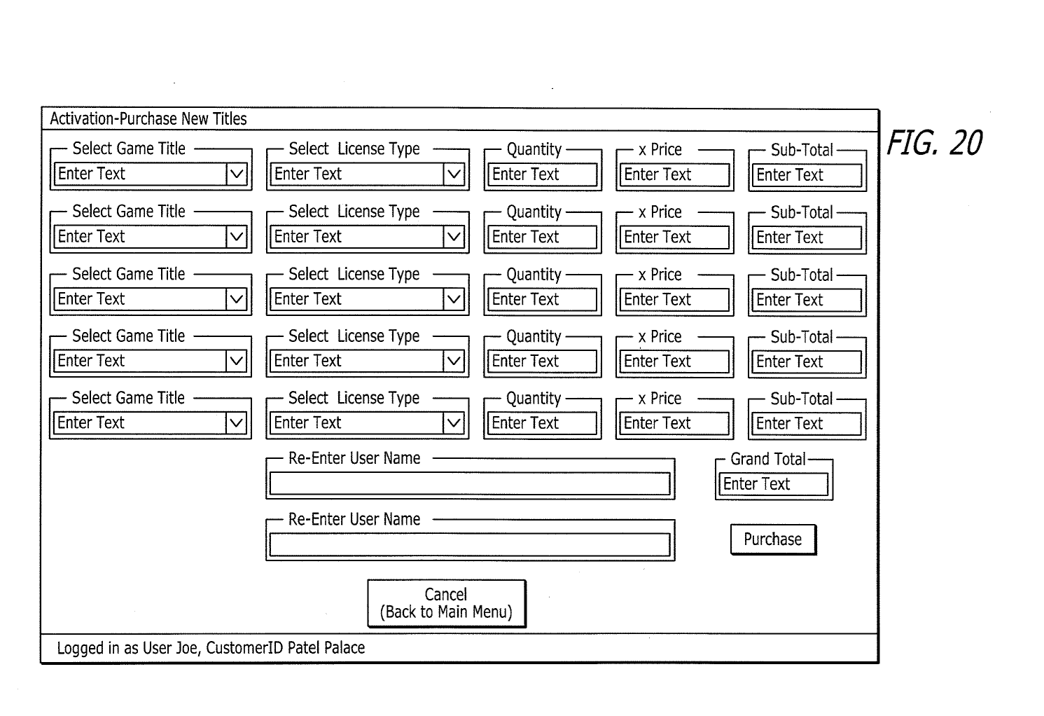

Referring now to FIG. 20, an embodiment of the Purchase New Titles Screen is shown. Preferably, this screen provides a new sales point. The Purchase New Titles Screen enables a user with a pre-established account with the manufacturer to purchase from the activation application any titles they may want. The user selects their desired game from the “Select Game Title” drop down and their desired license restrictions from “Select License Types.” The price per unit is displayed in the corresponding “Price” box. The user then selects the quantity of licenses to purchase, and repeats as necessary for other game titles. The subtotals per game, as well as and the grand total, are updated as options are selected.

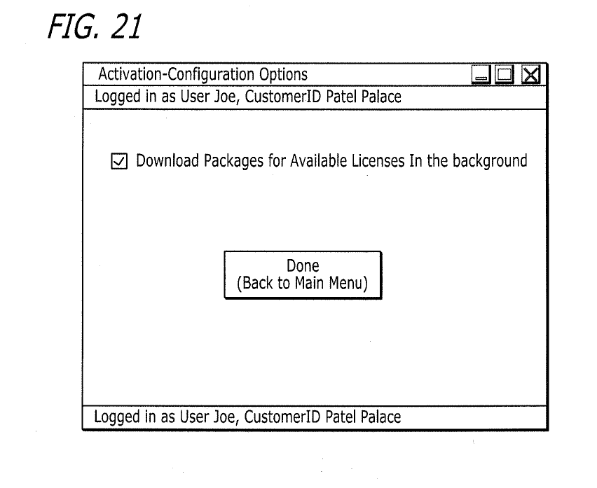

Before the purchase button is highlighted, the user preferably enters their user name and password again. Although the user is already logged on, in one embodiment this step is a security measure to ensure that if the activation application is left open and the logged in user leaves their terminal, no one may make large purchases in their name. Finally, referring to FIG. 21, an embodiment of the Configuration Options Screen is shown. Typically, the screen is used simply as a placeholder for future application configuration operations.

In one aspect of an embodiment, the Alpha II License Management System includes a communication module. The connection protocol between the Client and Host are built from the gaming network infrastructure. In one embodiment, the Client Control Module encapsulates the use of the gaming network infrastructure and defines messages between the Client and the Host. The message definitions may be reused for both the Client and the Host, as they define the same messages.

```
LoginRequest
    string LoginName
    string LoginPassword
LoginResponse
    bool Valid
ChangePassword
    uint32 TransactionID
    string LoginName
    string OldPassword
    string NewPassword
PasswordChangeResponse
    uint32 TransactionID
    bool Changed
ActivationRequest
    uint32 TransactionID
    string Theme
    string CustomerMachineIdentifier
ActivationResponseHeader
    uint32 TransactionID
    bool ActivationFound
    Blob ActivationCode
    string DownloadURL
StateReport
    uint32 TransactionID
    vector of Blobs
    Blob ActivationCode (for deactivated and downloaded, the code
    specially identifies)
StateReportResponse
    uint32 TransactionID
RequestCurrentLicenses
    // An activation code with Dallas ID all 0s indicates inactivated
    // An activation code with command value “3” indicates expecting
    deactivation
CurrentLicensesResponse
    vector of ReadableActivations
    Blob ActivationCode
    string GameTheme
    string PartNumber
    TimeSpan TimeActive
RequestPurchasableProducts
PurchasableProductResponse
    vector of Products
        string ReadableName
        string PartNumber
        uint64 Cost
        TimeSpan TimeActive
        vector of Jurisdictions
            string AllowedJurisdiction
ChangeProductData
    uint32 TransactionID
    string ReadableName
    string PartNumber
    uint64 Cost
    TimeSpan TimeActive
    vector of Jurisdictions
        string AllowedJurisdiction
ProductDataChangeResponse
    uint32 TransactionID
    bool Changed
RequestPurchase
    uint32 TransactionID
    vector of Purchases
        string PartNumber
        uint64 Cost
PurchaseResponse
    uint32 TransactionID
    bool Accepted
GetJurisdictions
JurisdictionList
    vector of Jurisdictions
        string JurisdictionName
GetCustomers
CustomerList
    vector of Customers
        uint32 CustomerID
        string FullName
        string Jurisdiction
        vector of EGMs
            string SerialNumber
            string CustomerMachineIdentifier
ChangeCustomerData
    uint32 TransactionID
    uint32 CustomerID
    string FullName
    string Jurisdiction
    vector of EGMs
        string SerialNumber
        string CustomerMachineIdentifier
CustomerDataChangeResponse
    uint32 TransactionID
    bool Changed
LoginAsRequest
    string UserName
    string Password
    string AsCustomer
LoginAsResponse
    bool Valid
```

In another aspect of one embodiment, the Alpha II License Management System includes a Client Control module. The Client Control module provides application logic for the client application. Additionally, the client control registers handlers into the Communications Module as well as enabling information to be pushed to the User Interface from various inputs. Furthermore, the Client Control module uses the Communications Module, the Local Image Manager, and the Hash Builder to process the input events and provide appropriate output. The Client Control module is a state machine that has the following states: Logged Off, Accumulating Activation Requests, Requesting Activation, and Burning Flash.

```
class ClientControl
{
public:
    void LogIn(LoginInfo);
    void ProcessLoginResponse(LoginResponseInfo);
    void LogInAs(LogInAsInfo);
    void ProcessLoginAsResponse(LoginAsResponseInfo);
    void ChangePassword(PasswordChangeInfo);
    void ProcessPasswordChangeResponse(PasswordChangeResponse);
    void AddActivationRequest(ActivationRequest);
    void ClearActivationRequests( );
    void SendActivationRequests( );
    void ProcessActivationResponse(ActivationResponse);
    void WriteMachineState(MachineState);
    void ProcessMachineStateResponse(MachineStateResponse);
    void RequestCurrentLicenses( );
    void ProcessCurrentLicensesResponse(CurrentLicenses);
    void RequestPurchasableProducts( );
    void ProcessPurchasableProductResponse(PurchasableProducts);
    void ChangeProductData(ProductData);
    void ProcessProductDataChangeResponse
    (ProductDataChangeResponse);
    void RequestPurchase(PurchaseInfo);
    void ProcessPurchaseResponse(PurchaseResponse);
    void GetJurisdictions( );
    void ProcessJurisdictionList(JurisdictionList);
    void GetCustomers( );
    void ProcessCustomerList(CustomerList);
    void ChangeCustomerData(CustomerData);
    void ProcessCustomerDataChangeResponse
    (CustomerDataChangeResponse);
};
```

In another aspect of one embodiment, the Alpha II License Management System includes a local image manager. Images for games purchased are stored on the local drive in an image management directory, once downloaded from the server or installed via compact flash. In one embodiment, the images are stored encrypted by the AES-256 algorithm, which is managed by the Local Image Manager.

```
enum ImageStatus
{
    NoImage,
    ImageLocal,
    ImageDownloading
};
class LocalImageManager
{
public:
    ImageStatus CheckImageLocal(PartNumber);
    void FetchImage(URL, DownloadCompleteHandler);
    ImageData DecryptImage(ImageRef);
};
```

In another aspect of one embodiment, the Alpha II License Management System includes a Flash Builder that is used to construct the partitions on a compact flash and transfer files to their proper partition. The Flash Builder manages the EXT2 file system on the flash, using the freeware filesystem driver.

```
class FlashBuilder
{
public:
    // Clear and partition flash memory image
    // and place standard Install OS and scripts in appropriate partition
    void ConstructInstallFlash( );
    void AddLicense(LicenseInfo);
    void AddImage(PartNumber);
    void BurnFlash(NumberToBurn);
};
```

In another embodiment of the license management system, the license policies define how licenses are to be accessed and how they are to be used. The System Operator can define and update these policies based on a variety of conditions. Customs and jurisdiction or corporate requirements are to be considered when creating the policy definitions. By way of example, the license policy is to take into consideration a layering of policies to reflect the hierarchy of clients such that a large multiple property casino client is given more of a benefit than a small client (e.g., small convenience store/tavern/bar). Also, certain states require policies to not allow certain types of gambling, and as such the policy is to reflect such requirements.

The policy creation process requires that only authorized people be allowed to update the policies. The policies are customizable (e.g., additional time allocations or via expanded content). For example, if a large multiple property casino entity desires additional time to use and benefit from certain licenses prior to the G2E event, then this privileged entity may be allowed a six-month term adjustment so as to operate the policies. This flexibility provides that the best benefits of the system can be provided to each entity.

The management of the license polices typically defines access to the license policies. The assignment of the license is layered, such that the policies can be set out in a hierarchical manner (i.e., the license either being used corporate-wide, jurisdiction-wide or statewide, for use by one casino, or by an individual user). The client with even one individual gaming machine 10 or a few gaming machines is to be allowed access to the license policies.

Additionally, the policies are available for specific, individual products, or tailored to individual vendors and/or entities. For example, for a large multiple property entity, such as a casino, it is desirable to create a specific policy. Note that such a policy, or all license management policies, are not available throughout all of the entity's site. The casino, as a large multiple property client is entitled to benefits, such as being given a 30-day trial period of newly licensed software products before being required to purchase. After 30 days, if the casino decides to keep the licensed software, then they are charged the license fee associated with the license following the six-month period, but not before. Also, as a large multiple property entity, the casino may be provided a prior viewing of newly developed products for different systems and products that will be available at a later time, and even the chance to view and purchase these earlier than other entities. On the other hand, smaller clients may not be entitled to 30-day trials or prior viewings.

Policies are to be defined to consider different state and jurisdictional requirements. Certain states may require that the policies preclude gambling in the state, so policy definition must include such a prohibition.

License status reports are provided in the defined license policies, are event based, and are pushed from the gaming device. The reports are available for a variety of needs, such as to show how many gaming devices are using a product. For example, if a casino seeks to buy 20 licenses, only 20 gaming devices are allowed to operate using the 20 provided licenses. However, upon the running of a license on the 21st gaming device, the policy determines how to proceed. For example, upon using the 21st gaming device, the casino may be notified that it is using more licenses than it is currently entitled to use under its contract. In this event, the casino must delete the extra license to the 21st gaming device within the next two days or be automatically billed for the extra license. Preferably, the previous example is the policy for any large multiple property casino client. For a smaller or single property casino client, however, the policy is defined so that immediately upon use by the 21st gaming device, the client is automatically billed for such extra use. No lag or courtesy time is provided under such policy definition.

In another embodiment, policy definition and usage may be used for implementation and updating. The policy provides license status reports that are event based, meaning that they are pushed from the gaming device. Also, the policy is associated with the multi-tiered clients with the system divided into multiple steps or phases, so that networked clients have the license management system collect or push the event status and send it, and the non-networked smaller client would need to get connected to send the status data. For example, the proper management license system for a smaller client, perhaps a single 7-11® store with only a few gaming devices, is to have the “ping” approach used to properly check which systems are in place. In this way, the client has to maintain each gaming device in network contact or else it is charged for a minimal number of such gaming devices. The timing of the “ping” is defined by the policy.

Additionally, the policy provides license status reports that are audit pulls, meaning central host pulls the data from the clients. For example, the central host pulls information from every client property, i.e., how many games each client is using. The client is open to pushing up this data to the central host, if the central license manager address is known. Whether the client is a large multiple property casino or a smaller client, the request is sent from the central host to the clients requesting that the clients send the day's report on the number of gaming devices in service. The reports from the clients should include the proper license count starting on a first date and ending on a second date. Upon receipt of these reports, the central host performs audits and then returns the reports to the clients. All this data can be transferred during minimum traffic periods and can otherwise be precluded at certain times to minimize disruption and bandwidth issues. This quick handshake exchange on a defined and timely basis is available for central license manager review.

In still another embodiment, multiple license configurations are available. Licenses have minimal data built therein, but they do contain enough to allow clients to use the game. If the client is licensed for twenty instances of a game, then the license is granted until the next update only for such twenty instances. The license could also be defined as unlimited, such that the client has access to as many licenses and game instances as desired. A license also can be restricted for a given term, such as for three months use only, or the client can have an established relation for as many licenses as they want as long as this client keeps paying a pre-defined compensation fee on a required basis.

The license management system defines what is considered or defined as a play. There are circumstances where licenses exist on the client's network, but the licenses may be dormant or exist in a different state such as perpetual, lease, revenue sharing, self-enabling, and the like. The central host manages and controls these licenses, determining when best to activate them. Certain clients, usually but not necessarily, large multiple property casino clients, are allowed to activate the software, and the central host is then provided status updates on how the clients are using the software licenses on their systems. There are fees charged for this self-activating management service, and these fees are set by the System Operator. The fees can be associated with a specified time period and/or how many times, the license management system determines use of the license. Preferably, the associated fee scale ranges from two or three cents up to twenty cents per event, whatever is appropriate. Of course, one of ordinary skill in the art will appreciate that any amount of fee may be used, and any method of triggering such fees may also be used.

In another embodiment, the license management system has the ability to monitor and track game use, e.g., how many games used, purchased, or refused a license. The tracked data is sent to the billing manager. The data sent includes purchasing the client's billing information, the time of activation of the license, a billed amount, a policy number, and the license type used. Thereafter, the billing manager knows the activation date and the bill amount and then automatically bills the client. The financial data events provided by the enterprise license manager are an example of a push model. An audit report is an example of a pull model. This allows the finance billing manager to be able to see game use and purchases by logging into the license management system and extracting a report.

With the defined architecture and process flow in place, products available for sale, and licenses able to be created, the system management point console verifies that all that is to be provided and distributed is properly authorized. The system management point console allows for the creation and sending of an authorization code that is associated with the name and identification number of the license. Then using the authorization code, the system management point console tracks and authenticates the license request. The local site operator and local license manager waits for the created license code(s) sent by the central host, and upon authentication, the download proceeds.

For example, a casino employee views a new product and is interested in purchasing a license for that product. However, the manager may not want the employee purchasing a license for that product, or the manager may require a purchase of two or more licenses. If the employee is still interested in a license purchase for that product, the employee makes a request for the license, and the system utilizes a notification mechanism using an authentication mechanism to indicate that the request is authorized. Once authorization is made, the provided authorization code is required to be inserted by the employee to enable use of the license.

Alternatively, the license setup can be configured so that the authorization code is built into the license. In this way, requests for products can be made without authorization, but the system then calls for an ID and password input. Thereafter, the system creates an authorization code at that time which is used to enable use of the product.

In one embodiment, the local site operator and site license personnel, usually for large multiple property casino clients, are given authority to self-activate licenses. The self-activating process allows a manager to request a license without knowing the full amount of licenses he requires. These types of requests are not ignored, and as described above, allow creation of an authorization code at the time of use for a license. In this embodiment, there is an integration of both the authorization and authentication mechanisms such that the local personnel can obtain an approved and authorized license at the time of the request from the central host and the central license manager.

In another aspect of one embodiment, a secure Ethernet connection is used to transmit information to and from gaming establishments over a public network using encryption. In one embodiment, the authentication and encryption used relies on the Secure Sockets Layer (SSL) trust model established to provide security for web traffic. Also, all necessary and confidential gaming content provided by the central host is available to the local site operator, gaming operator and patron clients via a plurality of conditional access systems. The central host distributes its content over the network, allowing the local site operators and patrons, large and small, access to this content via secure individual access rights. With ever increasing security and technical requirements, the central host uses a number of different conditional access systems, with each conditional access system typically requiring its own conditional access component. A conditional access component includes both hardware and software, with the software including a content provider's application loaded into the non-volatile memory of the component. The local site operator with just one conditional access component gains access to contents distributed with all the central host conditional access systems, and also is selectively enabled for any of the plurality of conditional access systems, subject to the successful acquisition of a license.

Alternative choices are to allow use of the certification process, public/private keys, or use of a different encryption mechanism. The options are not inclusive but provide for a system that is convenient for all parties.

To provide security assurances for the networked system, the network system is a separate system to itself, utilizing an independent security system server, with all the systems on the network being secured clients. The independent master security system server provides the security for all the networked clients. Even this central security system is also compliant for security reasons. The independent master security server is to perform constant security tests, including making false alarms, to provide assurances that the system is secure.

The security management interface allows the System Operator to monitor clients, including evaluation of how many processors are running on a client system. Having clients required to register onto the security server as well as via a separate server on the system allows for a running processor count that can be compared with previous existing client profiles to determine actual usage as compared with allowed usage per client. This monitors the process to determine which client is healthy and which client is not healthy, or which software is required and which software is not required.

As noted, the security system controls the conditional access for certificate expiration and/or rollover. All access and communications are to be encrypted. Security is to actively record logins, and attempted logins, to the network. Records include how many attempts, failed attempts and who did it lock on the system. Security is the guide to verify the system is secure and nothing is malfunctioning. The client is to keep security data as well and then transfer it to a central host.

Another License Management System embodiment related to the product licensing is the allowance to slice a product license per existing system components, such that licenses are part and parcel within the system at the component level. A hardware or software product is either a single entity or a composite of a number of features, with the variety of features provided by one or more vendors having other license policies. The License Management System feature here allows the use of one license for the collected parts making up the one product, or provide separate licenses for each part or component that collectively make this product. This includes licensing a product or a component to a client with a single gaming machine used one at a time, or to larger gaming clients having multiple gaming machines used by multiple patrons at any one time.

Additional features in this License Management System embodiment is the allowance related to licensing that certain games and equipment, including components, can be ‘rented out’ as a function of time. Compared to the ‘purchased’ fixed-length licensing model, in a ‘rented-out’ licensing mode a client has the allowance to support capacity on demand, with an advantage to not be required to replenish any capacity duration if it becomes depleted. The certain games and equipment rented out is covered under licensing agreements, with the amount of rentable time for the equipment or games based on the licenses. Relations with the clients can be defined and built for future engagements where the client uses un-planned capacity on the fly.

The various embodiments described above are provided by way of illustration only and should not be construed to limit the claimed invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed is:

1. A method for providing license management using an activation application to manage and enforce proper per-license activation, the method comprising:
providing a computer system including an active license database;
adding a purchased game title to the active license database;
requesting from the computer system activation installations for game titles that are desired to be activated on gaming machines on which the game titles are desired to be associated;
creating a portable install compact flash that associates activation installations to particular gaming machines;
installing software that is chosen by an operator, and destined by a license, for each gaming machine into which the software is inserted by enabling communication between the portable compact flash at each gaming machine, the software being installed onto a hard drive of each gaming machine from said portable compact flash;
returning the compact flash to the activation application, where the compact flash is read, after completion of the gaming machines being updated; and
passing a current snapshot to a central licensing host to confirm the activation installations and free any uninstalled software licenses.

2. The method of claim 1, further comprising having a customer or technician log into the activation application to request activation installations for game titles that are desired to be activated on gaming machines on which the game titles are desired to be associated.

3. The method of claim 1, wherein the compact flash is created as a step in a manufacturing process for a given game.

4. The method of claim 1, wherein the compact flash is generated locally on a computer having a flash burner and internet connection.

5. The method of claim 1, wherein the new software is installed over existing software.

6. The method of claim 6, wherein the new software is installed over the existing software by uninstalling the existing software and producing a new snapshot of current system installations.

7. The method of claim 7, wherein the snapshot of current system installations is stored on the compact flash.

8. The method of claim 1, wherein the license management system is capable of being used in any sized establishment including large multiple property casinos, a single property casino, or a convenience store, tavern, or bar.

9. The method of claim 1, wherein the license management system generates and maintains accounting records.

10. The method of claim 1, wherein the license management system generates an audit trail that includes an identification of who authorized the purchase of the license.

11. The method of claim 1, wherein the license management system generates an audit trail that relates to different system levels to verify system security.

12. The method of claim 1, wherein the license management system generates and maintains logs for licenses that are generated and distributed throughout the system.
